(19) United States
(12) Patent Application Publication
(10) Pub. No.: US 2019/0221180 A1
(43) Pub. Date: Jul. 18, 2019

(54) PIXEL STRUCTURE AND APPLICATION OF THE SAME TO DISPLAY PANEL

(71) Applicants: HKC Corporation Limited, Shenzhen City, Guangdong (CN); Chongqing HKC Optoelectronics Technology Co. Limited, Chongqing (CN)

(72) Inventor: Zeyao LI, Chongqing (CN)

(21) Appl. No.: 15/580,333

(22) PCT Filed: Sep. 19, 2017
(86) PCT No.: PCT/CN2017/102196

§ 371 Date: Dec. 7, 2017

(30) Foreign Application Priority Data
Aug. 25, 2017 (CN) 201710743945.6

(51) Int. Cl. G09G 3/36

(52) U.S. Cl. CPC G09G 3/3677; G09G 2300/0439; G09G 2300/0426; G09G 3/3688

(57) ABSTRACT

This application relates to a pixel structure and application of the same to a display panel. The pixel structure includes: pixel units arranged in an array and coupled to corresponding scan lines and a data line, wherein the pixel structure further comprises: a first pixel unit, including a first pixel circuit; a second pixel unit, including a second pixel circuit; and a shared switch, and a first terminal of the shared switch is coupled to a common electrode. The first pixel unit and the second pixel unit are coupled to different scan lines disposed at intervals, and a control terminal of the shared switch and the first pixel unit are coupled to a same scan line.

### BACKGROUND

### Technical Field

This application relates to a pixel design, and in particular, to a pixel structure and application of the same to a display panel.

### Related Art

A liquid crystal display (LCD) device displays images by using electrical and optical properties of liquid crystals. Liquid crystals are anisotropic. For example, a refractive index and a dielectric constant of a principal axis are different from those of a secondary axis in a molecule. A molecular arrangement and an optical property of liquid crystals can be easily adjusted. The LCD device adjusts a transmittance of light passing through a polarizer by means of changing directions of molecular arrangement of liquid crystals according to an order of magnitude of an electric field, to display an image.

An LCD device includes a liquid crystal panel and a drive circuit. A plurality of pixels is arranged in a form of a matrix in the liquid crystal panel. The drive circuit includes a gate driver for driving a scan line of the liquid crystal panel and a data driver for driving a data line of the liquid crystal panel. For example, in a double rate driving (DRD) or a triple rate driving (TRD) LCD device, two or three horizontally adjacent subpixels are connected to a single data line, and are sequentially driven by different scan lines.

At present, to reduce power consumption of a display, an alternating current driving method used in many products is a column 2-dot inversion. The column 2-dot inversion is a synthesis of a column inversion and a dot inversion, and is represented by that two subpixels (2 dots) are used as a unit in each column, so that a positive polarity and a negative polarity of the two subpixels are inverted. A column is used as a unit for two adjacent columns of subpixels, so that a positive polarity and a negative polarity of the two columns are inverted. From the perspective of a drive waveform, a data drive IC invertedly drives a signal voltage by using two addressing time periods (two Hsync periods) as a unit, and a waveform frequency thereof is between that of the dot inversion and that of the column inversion. Therefore, power consumption of the column 2-dot inversion is much lower than that of the dot inversion.

However, two adjacent pixels (2 dots) in a same column have a same polarity, and delays for data signals to arrive at two adjacent pixels are significantly different. Therefore, luminances of the two adjacent pixels are different, and a problem of horizontal or vertical bright and dark lines is caused during display, affecting the display quality. Such a phenomenon is especially obvious at a low gray level. However, currently, there is no universal standard in how to quantify degrees of horizontal or vertical bright and dark lines of a product.

Therefore, this application provides a simple method for quantifying degrees of horizontal or vertical bright and dark lines, which implements quantification of the horizontal or vertical bright and dark lines by means of comparing luminances of two different images.

### SUMMARY

To resolve the foregoing technical problem, an objective of this application is to provide a method for quantifying degrees of horizontal or vertical bright and dark lines, and in particular, this application relates to a pixel structure and application of the same to a display panel, thereby not only effectively making the display panel smoother but also quantifying degrees of displayed bright and dark lines.

The objective of this application is achieved and the technical problem of this application is resolved by using the following technical solutions. A pixel structure provided according to this application comprises: a plurality of pixel units arranged in an array and coupled to corresponding scan lines and a data line, wherein the pixel structure further comprises: a first pixel unit, comprising a first pixel circuit; a second pixel unit, comprising a second pixel circuit; and a shared switch, and a first terminal of the shared switch is coupled to a common electrode. The first pixel unit and the second pixel unit are coupled to different scan lines disposed at intervals, and a control terminal of the shared switch and the first pixel unit are coupled to a same scan line. The first pixel unit and the second pixel unit are simultaneously charged or discharged, or are simultaneously not charged or discharged, or only one of the first pixel unit and the second pixel unit is charged or discharged.

The objective of this application may further be achieved and the technical problem of this application may further be resolved by using the following technical measures.

Another objective of this application is a pixel structure, comprising: a plurality of pixel units arranged in an array and coupled to corresponding scan lines and a data line, wherein the pixel structure further comprises: a first pixel unit, comprising a first pixel circuit; a second pixel unit, comprising a second pixel circuit; and a shared switch, and a first terminal of the shared switch is coupled to a common electrode. The first pixel unit and the second pixel unit are coupled to different scan lines disposed at intervals, and a control terminal of the shared switch and the first pixel unit are coupled to a same scan line. The first pixel unit and the second pixel unit are simultaneously charged or discharged, or are simultaneously not charged or discharged, or only one of the first pixel unit and the second pixel unit is charged or discharged; the first pixel unit and the second pixel unit are connected to a same data line; the first pixel unit and the second pixel unit are connected to different scan lines; and the pixel structure is disposed on a substrate.

Yet another objective of this application is a display panel, comprising the pixel structure.

In an embodiment of this application, the first pixel unit and the second pixel unit are connected to a same data line; and the first pixel unit and the second pixel unit are connected to different scan lines.

In an embodiment of this application, a second terminal of the shared switch is coupled to a second pixel circuit of a second pixel unit in a next pixel row.

In an embodiment of this application, during a first scanning period, an n^{th} scan line is at a high potential, the first pixel unit is charged or discharged, the shared switch is turned on, and the second pixel unit of the next pixel row performs charge sharing, n being a positive number.

In an embodiment of this application, during a second scanning period, an (n+2)^{th} scan line is at a high potential, the shared switch is turned off, and the second pixel unit of the next pixel row is charged.

In an embodiment of this application, a second terminal of the shared switch is coupled to a first pixel circuit of a first pixel unit in a next pixel row.

In an embodiment of this application, during a first, scanning period, an n^{th} scan line is at a high potential, the first pixel unit is charged or discharged, the shared switch is turned on, and the first pixel unit of the next pixel row performs charge sharing, n being a positive number.

In an embodiment of this application, during a second scanning period, an (n+1)^{th} scan line is at a high potential, the shared switch is turned off, and the first pixel unit of the next pixel row is charged.

This application can make the display panel smoother, and quantifies degrees of displayed bright and dark lines.

### BRIEF DESCRIPTION OF THE DRAWINGS

FIG. 1 is an exemplary schematic diagram of a DRD panel;

FIG. 2 is a schematic diagram of a DRD panel according to an embodiment of this application;

FIG. 3 is a schematic diagram of a DRD panel according to another embodiment of this application;

FIG. 4 is a schematic diagram of an active switch connection in a pixel structure of a DRD panel according to an embodiment of this application; and

FIG. 5 is a schematic diagram of an active switch connection in a pixel structure of a DRD panel according to another embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using a same reference numeral. In addition, for understanding and ease of description, the size and the thickness of each component shown in the accompanying drawings are arbitrarily shown, but this application is not limited thereto.

In the accompanying drawings, for clarity, the thicknesses of a layer, a film, a panel, an area, and the like are exaggerated. In the accompanying drawings, for understanding and ease of description, the thicknesses of some layers and areas are exaggerated. It should be understood that when a component such as a layer, a film, an area, or a base is described to be “on” another component, the component may be directly on the another component, or there may be an intermediate component.

In addition, in this specification, unless explicitly described to have an opposite meaning, the word “include” is understood as including the component, but not excluding any other component. In addition, in this specification, “on” means that a component is located above or below a target component, but does not mean that the component needs to be located on the top based on the direction of gravity.

To further describe the technical measures taken in this application to achieve the intended objectives and effects thereof, specific implementations, structures, features, and effects of a pixel structure and application of the same to a display panel provided according to this application are described below in detail with reference to the accompanying drawings and preferred embodiments.

The display panel of this application may include an LCD panel, including a switch array (TFT) substrate, a color filter (CF) substrate, and a liquid crystal layer formed between the two substrates, or may be an organic light-emitting diode (OLED) panel or a quantum dots light-emitting diode (QLED) panel (but is not limited thereto).

In an embodiment, the display panel of this application may be a curved-surface display panel.

In an embodiment, a TFT and a CF of this application may be formed on a same substrate.

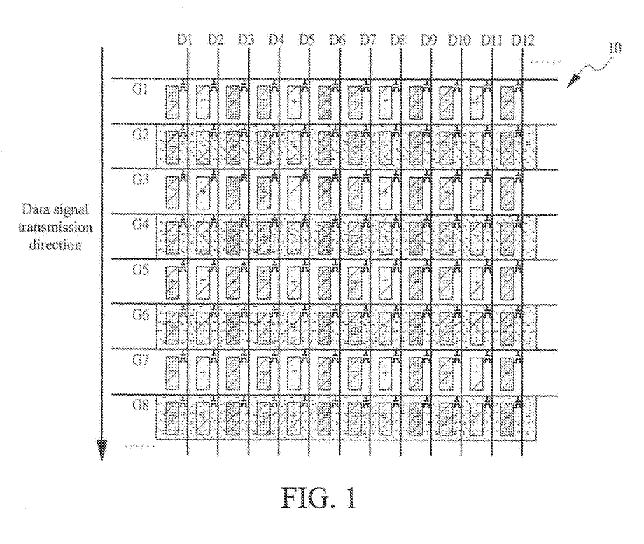

FIG. 1 is an exemplary schematic diagram of a DRD panel. Referring to FIG. 1, FIG. 1 shows a DRD panel 10, and describes the principle of horizontal bright and dark lines formed by a column 2-dot inversion. For two adjacent subpixels that are in a same column and of a same polarity, a signal of the former subpixel is obtained by changing a signal of an opposite polarity, and a signal of the latter subpixel is obtained by changing a signal of the same polarity. Therefore, a signal delay of a signal of a data line of the former subpixel is severer than that of the latter subpixel, and during charging and discharging processes, the charging efficiency of the latter subpixel is better than that of the former subpixel, causing a difference between luminances of the two adjacent subpixels. A subpixel with a severe signal delay has a relatively low charging efficiency and is referred to as a dark pixel. A subpixel with a nonsevere signal delay has relatively high charging efficiency and is referred to as a bright pixel. In this way, the horizontal bright and dark lines shown in FIG. 1 are formed.

Referring to FIG. 1, in an embodiment, a design of a DRD panel 10 usually uses a 2-line driving method or a 1+2-line driving method. If the 2-line driving method is used as an example, data signals obtained by pixels in an N^{th} column of scan lines are more complete than those obtained by pixels in an (N+1)^{th} column of scan lines due to an information signal delay of a data line. Therefore, a luminance difference occurs on a gray level image. A pixel with constant switching between a positive signal and a negative signal is relatively dark. In this case, the horizontal bright and dark lines shown in FIG. 1 appear.

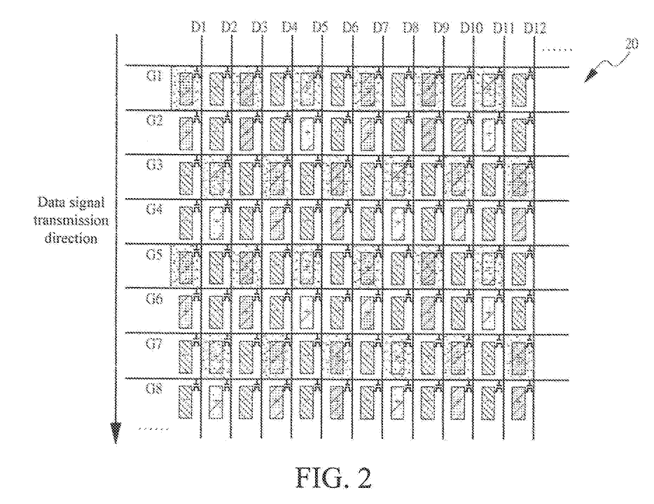

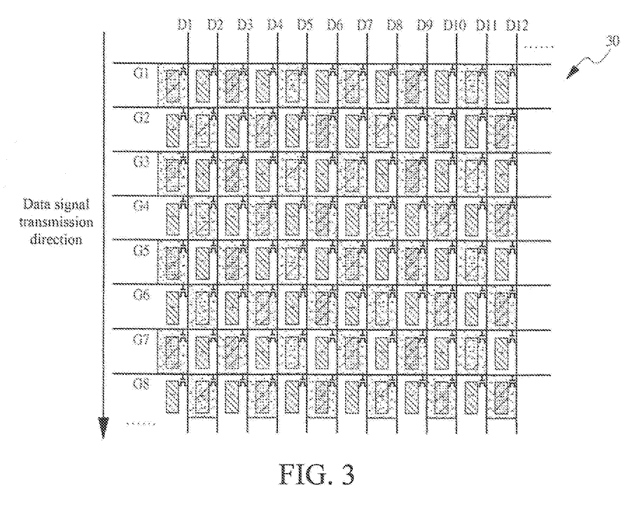

FIG. 2 is a schematic diagram of a DRD panel according to an embodiment of this application, and FIG. 3 is a schematic diagram of a DRD panel according to another embodiment of this application. Referring to FIG. 2, in an embodiment, by means of a design of a DRD panel 20, in each data line, two subpixels of a same polarity are simultaneously turned on or simultaneously not turned on and are spaced from each other by a subpixel with an opposite polarity. That is, in a data line column 1, active array switches in pixel rows in which scan lines 1, 2, 5, 6, and the like are located are turned on; in a data line column 2, active array switches in pixel rows in which scan lines 3, 4, 7, 8, and the like are located are turned on; in a data line column 3, active array switches in pixel rows in which scan. lines 1, 2, 5, 6, and the like are located are turned on; and in a data line column 4, active array switches in pixel rows in which scan lines 3, 4, 7, 8, and the like are located are turned on. In this way, there are half dark pixels and half bright pixels. For horizontal and vertical bright and dark lines in all cases, images including uniformly distributed subpixels that are of a same quantity and type but including dark pixels and bright pixels that are of different proportions can be designed to compare luminances of the two images and quantify the degrees of the horizontal or vertical bright and dark lines. Therefore, this design is suitable for all bright and dark lines caused by a column 2-dot inversion, not only including horizontal bright and dark lines.

Referring to FIG. 3, in an embodiment, by means of a design of a DRD panel 30, in each data line, only the former subpixel of two subpixels of a same polarity is turned on. That is, in a data line column 1, active array switches in pixel rows in which scan lines 1, 3, 5, 7, and the like are located are turned on; in a data line column 2, active array switches in pixel rows in which scan lines 2, 4, 6, 8, and the like are located are turned on; in a data line column 3, active array switches in pixel rows in which scan lines 1, 3, 5, 7, and the like are located are turned on; and in a data line column 4, active array switches in pixel rows in which scan lines 2, 4, 6, 8, and the like are located are turned on. In this way, all the pixels are dark pixels, luminances of two images are different, and this difference is caused by bright and dark lines and determined by bright and dark degrees of the bright and dark lines. Therefore, by means of comparing luminance differences between the two images, the degrees of horizontal bright and dark lines can be quantified. For horizontal and vertical bright and dark lines in all cases, images including uniformly distributed subpixels that are of a same quantity and type but including dark pixels and bright pixels that are of different proportions can be designed to compare luminances of the two images and quantify the degrees of the horizontal or vertical bright and dark lines. Therefore, this design is suitable for all bright and dark lines caused by a column 2-dot inversion, not only including horizontal bright and dark lines.

Referring to FIG. 2 and FIG. 3, by designing two images that include uniformly distributed subpixels that are of a same quantity and type but include dark pixels and bright pixels that are of different proportions and then measuring the luminance differences between the two images, horizontal bright and dark lines are quantified.

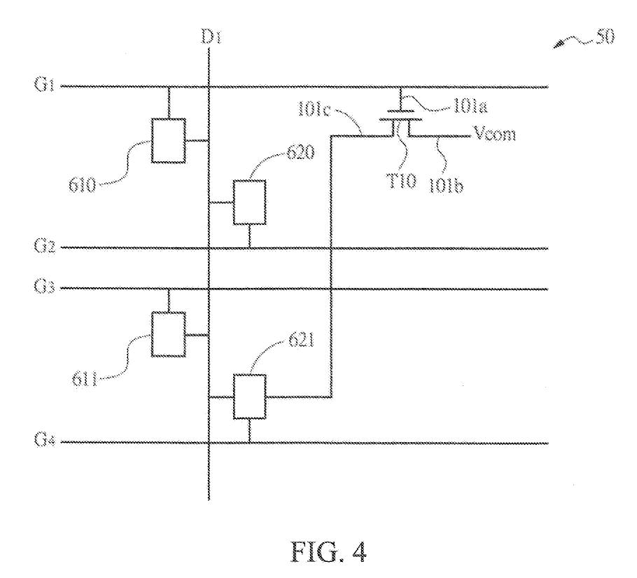

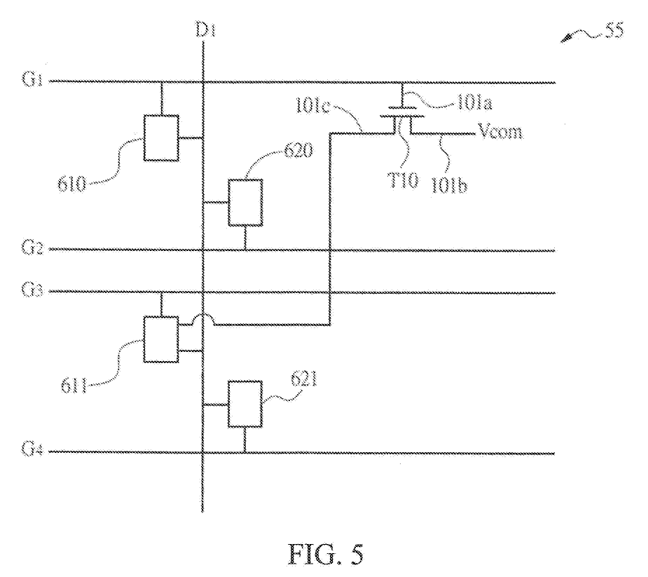

FIG. 4 is a schematic diagram of an active switch connection in a pixel structure of a DRD panel according to an embodiment of this application, and FIG. 5 is a schematic diagram of an active switch connection in a pixel structure of a DRD panel according to another embodiment of this application. Referring to FIG. 2 and FIG. 4, in an embodiment of this application, a pixel structure 50 includes: a plurality of pixel units 610, 611, 620, and 621 arranged in an array and coupled to corresponding scan lines G1, G2, G3, and G4 and a data line D1, and includes: first pixel units 610 and 611, including first pixel circuits 610 and 611; second pixel units 620 and 621, including second pixel circuits 620 and 621; and a shared switch T10, where a first terminal 101b of the shared switch T10 is coupled to a common electrode Vcom. The first pixel units 610 and 611 and the second pixel units 620 and 621 are coupled to different scan lines G1, G2, G3, and G4 configured at intervals, and a control terminal 101a of the shared switch T10 and the first pixel unit 610 are coupled to a same scan line G1. The first pixel units 610 and 611 and the second pixel units 620 and 621 are simultaneously charged or discharged, or are simultaneously not charged or discharged, or only one of the first pixel unit and the second pixel unit is charged or discharged.

Referring to FIG. 2 and FIG. 4, in an embodiment, the first pixel units 610 and 611 and the second pixel units 620 and 621 are connected to a same data line D1; and the first pixel units 610 and 611 and the second pixel units 620 and 621 are connected to different scan lines G1, G2, G3, and G4.

Referring to FIG. 2 and FIG. 4, in an embodiment, a second terminal 101c of the shared switch T10 is coupled to the second pixel circuit 621 of the second pixel unit 621 in a next pixel row.

Referring to FIG. 2 and FIG. 4, in an embodiment, during a first scanning period, an n^{th} scan line G1 is at a high potential, the first pixel unit 610 is charged or discharged, the shared switch T10 is turned on, and the second pixel unit 621 of the next pixel row performs charge sharing, n being a positive number.

Referring to FIG. 2 and FIG. 4, in an embodiment, during a second scanning period, an (n+2)^{th} scan line G3 is at a high potential, the shared switch T10 is turned off, and the second pixel unit 621 of the next pixel row is charged.

Referring to FIG. 3 and FIG. 5, in an embodiment of this application, a pixel structure 55 includes: a plurality of pixel units 610, 611, 620, and 621 arranged in an array and coupled to corresponding scan lines G1, G2, G3, and G4 and a data line D1, and includes: first pixel units 610 and 611, including first pixel circuits 610 and 611; second pixel units 620 and 621, including second pixel circuits 620 and 621; and a shared switch T10, where a first terminal 101b of the shared switch T10 is coupled to a common electrode Vcom. The first pixel units 610 and 611 and the second pixel units 620 and 621 are coupled to different scan lines G1, G2, G3, and G4 configured at intervals, and a control terminal 101a of the shared switch T10 and the first pixel unit 610 are coupled to a same scan line G1. The first pixel units 610 and 611 and the second pixel units 620 and 621 are simultaneously charged or discharged, or are simultaneously not charged or discharged, or only one of the first pixel unit and the second pixel unit is charged or discharged.

Referring to FIG. 3 and FIG. 5, in an embodiment, the first pixel units 610 and 611 and the second pixel units 620 and 621 are connected to a same data line Dl; and the first pixel units 610 and 611 and the second pixel units 620 and 621 are connected to different scan lines G1, G2, G3, and G4.

Referring to FIG. 3 and FIG. 5, in an embodiment, a second terminal 101c of the shared switch T10 is coupled to the first pixel circuit 611 of the first pixel unit 611 in a next pixel row.

Referring to FIG. 3 and FIG. 5, in an embodiment, during a first scanning period, an n^{th} scan line G1 is at a high potential, the first pixel unit 610 is charged or discharged, the shared switch T10 is turned on, and the first pixel unit 611 of the next pixel row performs charge sharing, n being a positive number.

Referring to FIG. 3 and FIG. 5, in an embodiment, during a second scanning period, an (n+1)^{th} scan line G2 is at a high potential, the shared switch T10 is turned off, and the second pixel unit 621 of the next pixel row is charged.

Referring to FIG. 4, in an embodiment, a pixel structure 50 includes: a plurality of pixel units 610, 611, 620, and 621 arranged in an array and coupled to corresponding scan lines G1, G2, G3, and G4 and a data line D1, and includes: first pixel units 610 and 611, including first pixel circuits 610 and 611; second pixel units 620 and 621, including second pixel circuits 620 and 621; and a shared switch T10, where a first terminal 101b of the shared switch T10 is coupled to a common electrode Vcom. The first pixel units 610 and 611 and the second pixel units 620 and 621 are coupled to different scan lines G1, G2, G3, and G4 configured at intervals, and a control terminal 101a of the shared switch T10 and the first pixel unit 610 are coupled to a same scan line G1. The first pixel units 610 and 611 and the second pixel units 620 and 621 are simultaneously charged or discharged, or are simultaneously not charged or discharged, or only one of the first pixel unit and the second pixel unit is charged or discharged. The first pixel units 610 and 611 and the second pixel units 620 and 621 are connected to a same data line D1. The first pixel units 610 and 611 and the second pixel units 620 and 621 are connected to different scan lines G1, G2, G3, and G4. The pixel structure 50 is disposed on a substrate (not shown in the figure).

Referring to FIG. 5, in an embodiment, a pixel structure 55 includes: a plurality of pixel units 610, 611, 620, and 621 arranged in an array and coupled to corresponding scan lines G1, G2, G3, and G4 and a data line D1, and includes: first pixel units 610 and 611, including first pixel circuits 610 and 611; second pixel units 620 and 621, including second pixel circuits 620 and 621; and a shared switch T10, where a first terminal 101b of the shared switch T10 is coupled to a common electrode Vcom. The first pixel units 610 and 611 and the second pixel units 620 and 621 are coupled to different scan lines 01, G2, G3, and G4 configured at intervals, and a control terminal 101a of the shared switch T10 and the first pixel unit 610 are coupled to a same scan line G1. The first pixel units 610 and 611 and the second pixel units 620 and 621 are simultaneously charged or discharged, or are simultaneously not charged or discharged, or only one of the first pixel unit and the second pixel unit is charged or discharged. The first pixel units 610 and 611 and the second pixel units 620 and 621 are connected to a same data line D1. The first pixel units 610 and 611 and the second pixel units 620 and 621 are connected to different scan lines G1, G2, G3, and G4. The pixel structure 55 is disposed on a substrate (not shown in the figure).

In an embodiment, a display panel includes the pixel structure 50 or 55.

This application can make a display panel smoother, and quantifies degrees of displayed bright and dark lines.

The terms such as “in some embodiments” and “in various embodiments” are repeatedly used. The terms usually refer to different embodiments, but they may also refer to a same embodiment. The words, such as “comprise”, “have”, and “include”, are synonyms, unless other meanings are indicated in the context thereof.

Descriptions above are merely preferred embodiments of this application, and are not intended to limit this application in any form. Although this application has been disclosed above in forms of preferred embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A pixel structure, comprising: a plurality of pixel units arranged in an array and coupled to corresponding scan lines and a data line, wherein the pixel structure further comprises:
a first pixel unit, comprising a first pixel circuit;
a second pixel unit, comprising a second pixel circuit; and
a shared switch, wherein a first terminal of the shared switch is coupled to a common electrode, and
the first pixel unit and the second pixel unit are coupled to different scan lines disposed at intervals, and a control terminal of the shared switch and the first pixel unit are coupled to a same scan line; and the first pixel unit and the second pixel unit are simultaneously charged or discharged, or are simultaneously not charged or discharged, or only one of the first pixel unit and the second pixel unit is charged or discharged.

2. The pixel structure according to claim 1, wherein the first pixel unit and the second pixel unit are connected to a same data line.

3. The pixel structure according to claim 1, wherein the first pixel unit and the second pixel unit are connected to different scan lines.

4. The pixel structure according to claim 1, wherein a second terminal of the shared switch is coupled to a second pixel circuit of a second pixel unit in a next pixel row.

5. The pixel structure according to claim 4, wherein during a first scanning period, an n^{th} scan line is at a high potential, the first pixel unit is charged or discharged, the shared switch is turned on, and the second pixel unit of the next pixel row performs charge sharing, n being a positive number.

6. The pixel structure according to claim 4, wherein during a second scanning period, an (n+2)^{th} scan line is at a high potential, the shared switch is turned off, and the second pixel unit of the next pixel row is charged.

7. The pixel structure according to claim 1, wherein a second terminal of the shared switch is coupled to a first pixel circuit of a first pixel unit in a next pixel row.

8. The pixel structure according to claim 7, wherein during a first scanning period, an n^{th} scan line is at a high potential, the first pixel unit is charged or discharged, the shared switch is turned on, and the first pixel unit of the next pixel row performs charge sharing, n being a positive number.

9. The pixel structure according to claim 7, wherein during a second scanning period, an (n+1)^{th} scan line is at a high potential, the shared switch is turned off, and the first pixel unit of the next pixel row is charged.

10. A pixel structure, comprising: a plurality of pixel units arranged in an array and coupled to corresponding scan lines and a data line, wherein the pixel structure further comprises:
a first pixel unit, comprising a first pixel circuit;
a second pixel unit, comprising a second pixel circuit; and
a shared switch, wherein a first terminal of the shared switch is coupled to a common electrode, and
the first pixel unit and the second pixel unit are coupled to different scan lines disposed at intervals, and a control terminal of the shared switch and the first pixel unit are coupled to a same scan line; the first pixel unit and the second pixel unit are simultaneously charged or discharged, or are simultaneously not charged or discharged, or only one of the first pixel unit and the second pixel unit is charged or discharged; the first pixel unit and the second pixel unit are connected to a same data line; the first pixel unit and the second pixel unit are connected to different scan lines; and the pixel structure is disposed on a substrate.

11. A display panel, comprising:
a pixel structure, comprising: a plurality of pixel units arranged in an array and coupled to corresponding scan lines and a data line, wherein the pixel structure further comprises
a first pixel unit, comprising a first pixel circuit;
a second pixel unit, comprising a second pixel circuit; and
a shared switch, wherein a first terminal of the shared switch is coupled to a common electrode, and
the first pixel unit and the second pixel unit are coupled to different scan lines disposed at intervals, and a control terminal of the shared switch and the first pixel unit are coupled to a same scan line; and the first pixel unit and the second pixel unit are simultaneously charged or discharged, or are simultaneously not charged or discharged, or only one of the first pixel unit and the second pixel unit is charged or discharged.

12. The display panel according to claim 11, wherein the first pixel unit and the second pixel unit are connected to a same data line; and the first pixel unit and the second pixel unit are connected to different scan lines.

13. The display panel according to claim 11, wherein a second terminal of the shared switch is coupled to a second pixel circuit of a second pixel unit in a next pixel row.

14. The display panel according to claim 13, wherein during a first scanning period, an n^{th} scan line is at a high potential, the first pixel unit is charged or discharged, the shared switch is turned on, and the second pixel unit of the next pixel row performs charge sharing, n being a positive number.

15. The display panel according to claim 13, wherein during a second scanning period, an (n+2)^{th} scan line is at a high potential, the shared switch is turned off, and the second pixel unit of the next pixel row is charged.

16. The display panel according to claim 11, wherein a second terminal of the shared switch is coupled to a first pixel circuit of a first pixel unit in a next pixel row.

17. The display panel according to claim 16, wherein during a first scanning period, an n^{th} scan line is at a high potential, the first pixel unit is charged or discharged, the shared switch is turned on, and the first pixel unit of the next pixel row performs charge sharing, n being a positive number.

18. The display panel according to claim 16, wherein during a second scanning period, an (n+1)^{th} scan line is at a high potential, the shared switch is turned off, and the first pixel unit of the next pixel row is charged.
